(19) United States
(12) Patent Application Publication
(10) Pub. No.: US 2005/0004738 A1
(43) Pub. Date: Jan. 6, 2005

(54) Method for modifying a driving stability control of a vehicle

(76) Inventors: Ralph Gronau, Wetter (DE); Torsten Herrmann, Frankfurt am Main (DE); Artur Kost, Bad Soden (DE); Peter Wanke, Frankfurt am Main (DE)

Correspondence Address: Gerlinde M Nattler;Continental Teves Inc, One Continental Drive, Auburn Hills, MI, 48326, US

(21) Appl. No.: 10/481,664

(22) PCT Filed: Jun. 28, 2002
(86) PCT No.: PCT/EP02/07173

(30) Foreign Application Priority Data
Jun. 28, 2001 (DE) 101 30 663.6

(51) Int. Cl. G06F 7/70

(52) U.S. Cl. 701/70

(57) ABSTRACT

The present invention relates to a method for modifying a driving stability control of a vehicle wherein the input variables essentially composed of the predetermined steering angle (δ) and the driving speed (v) are converted into a nominal value of the yaw velocity (\dot{Ψ}ₙₒₘᵢₙₐₗ) on the basis of a vehicle model defined by running characteristics. The nominal value is compared with a measured actual value of the yaw velocity (\dot{Ψ}_{measured}), and an additional yaw torque (M_{G}) is calculated in an ESP controller according to the result of the comparison and used to define an ESP intervention which produces an additional yaw torque by way of pressure quantities applied to the wheel brakes of the vehicle.

### TECHNICAL FIELD

The present invention generally relates to methods for controlling vehicle stability, and more particularly relates to a method for modifying a driving stability control of a vehicle wherein the input variables are essentially composed of the predetermined steering angle (δ) and the driving speed (v).

### BACKGROUND OF THE INVENTION

Vehicle instabilities are likely to occur in defined driving situations when the vehicle speed is not adapted to current conditions. Various driving stability control systems have become known in the art that aim at automatically counteracting vehicle instabilities.

There are basically five principles of influencing the driving performance of a vehicle by means of predeterminable pressures or brake forces in or at individual wheel brakes and by means of intervention into the engine management of the driving engine. These principles are brake slip control (ABS) intended to prevent individual wheels from locking during a braking operation, traction slip control (TSC) preventing the driven wheels from spinning, electronic brake force distribution (EBV) controlling the ratio of brake forces between front and rear axle of the vehicle, anti rollover braking (ARB) preventing rollover of the vehicle about its longitudinal axis, as well as yaw torque control (ESP) ensuring stable driving conditions when the vehicle yaws about its vertical axis.

Hence, the term ‘vehicle’ in this context implies a motor vehicle with four wheels, which is equipped with a hydraulic, electrohydraulic or electromechanical brake system. The driver is able to develop brake pressure in the hydraulic brake system by means of a pedal-operated master cylinder, while the electrohydraulic and electromechanical brake systems develop a brake force responsive to the sensed braking demand of the driver.

Further, the vehicle is equipped with a thermodynamic or electric driving system applying traction torque depending on the driver's demand to at least one wheel of the vehicle by way of the drive train.

To sense driving-dynamics conditions, there are four rotational speed sensors, one per wheel, i.e. one yaw velocity sensor, one lateral acceleration sensor, and at least one pressure sensor for the brake pressure generated by the brake pedal. Instead of the pressure sensor, a pedal-travel or pedal-force sensor may also be used if the auxiliary pressure source is so arranged that brake pressure built up by the driver cannot be distinguished from the brake pressure of the auxiliary pressure source. The driving torque currently generated by the driving system and the torque the driver demands are determined in addition. These variables may also be variables that are indirectly determined, e.g. derived from engine performance characteristics.

The driving performance of a vehicle is influenced in a driving stability control operation so that the vehicle is better to master for the driver in critical situations. A critical situation in this respect is an unstable driving condition when the vehicle will not follow the instructions of the driver in the extreme case. Thus, the function of driving stability control is to impart to the vehicle the vehicle performance the driver requests, within the physical limits in such situations. While longitudinal slip of the tires on the roadway is significant in first place for brake slip control, traction slip control and electronic brake force distribution, further variables are included in yaw torque control (YTC), for example, the yaw rate and tire slip angle velocity.

All vehicles whose center-of-gravity height in relation to the track exceeds a critical value (typically sports utility vehicles, off-road vehicles, etc.) are jeopardized by an unstable roll condition, the so-called rollover, when a critical lateral acceleration value is exceeded. This limit value may be reduced e.g. by increase of the vehicle mass in terms of the maximum allowable load and mostly, as a result, rise of the vehicle's center-of-gravity into ranges which can be reached in a quasi-stationary cornering maneuver even when the driving style during operation is not in conformity with the situation. A driving style that is not in conformity with the situation implies that the driver follows the course of a curve at a speed, which causes an excessive lateral acceleration due to the steering angle necessary for the predetermined curve radius. Of course, the case may also occur (which is less frequent in practice though) that the driver does not have to follow a course of a curve but freely predefines the steering angle and, due to this specification with respect to its current speed, enters into inadmissible ranges of lateral acceleration (e.g. slow inward turning of the steering wheel during a turning maneuver on a parking lot). A rising speed at a constant curve radius may also cause the critical rollover situation.

An object of the present invention is to disclose a method and a control for avoiding imminent rollover situations, while another objective is to maintain the ideal course predetermined by the driver to the greatest degree possible.

This object is achieved according to the present invention in that the coefficient of friction is limited to a value below the maximum allowable coefficient of friction (μₘₐₓ) in dependence on variables representative of at least one limit lateral acceleration or variables derived therefrom.

This makes possible a well-defined lateral acceleration limitation to avoid rollover hazards.

Another object of the invention is to modify ESP control to such effect that the ESP control commences when the driving performance of a vehicle is still stable under ESP criteria, according to a limitation of an input variable of a reference model determining the running characteristics, in particular the linear single-track model. Preferably the lateral acceleration, the coefficient of friction, and/or the steering angle velocity are limited as input variables.

When a lateral acceleration that exceeds a critical value is detected during a cornering maneuver (quasi-stationary circular course), which is rendered plausible by the steering angle and the yaw rate, a special control mode of this ESP control will start. In this special control mode, the ESP control controls the performance of the vehicle at a point of time when stable performance still prevails under ESP criteria. Admittedly, a nominal yaw rate is defined as a specification according to the selected vehicle reference model in the special control mode, however, this vehicle reference model is so detuned according to an input variable, preferably a limit value of the lateral acceleration, of the coefficient of friction, and/or the steering angle velocity that the control commences already with the stable vehicle performance. As this occurs, the vehicle reference model may be designed as neutral or understeering. The input variable also reduces the value of the nominal yaw rate modeled in the vehicle reference model. The so reduced nominal yaw rate is compared to the measured actual yaw rate, and an additional yaw torque is calculated in the ESP control according to the result of the comparison. By limitation of the input variables, the nominal yaw rate forces the control towards an understeering performance of the vehicle due to an oversteering intervention. In an ESP oversteering intervention, brake pressure is introduced into at least the curve-outward front-wheel brake. An offset value which is e.g. speed-responsive, can be added to the nominal yaw rate according to another embodiment. The course of the yaw rate offset may additionally be configured in response to lateral acceleration in such a way that it is rated higher at higher lateral acceleration values. This enhances the understeering tendency of the vehicle.

Favorably, the ESP control algorithms remain unchanged. The oversteering intervention initiated in the imminent rollover situation induces the vehicle to an understeering performance. In addition, the provisions in the range of high lateral acceleration prevent understeering interventions which lead the vehicle back to neutral range because these understeering interventions augment the rollover hazard.

### BRIEF DESCRIPTION OF THE DRAWINGS

FIG. 1 is a schematic view of the vehicle hardware used to implement the current invention.

FIG. 2 is a logic flow diagram of the method of the present invention.

### DETAILED DESCRIPTION OF THE INVENTION

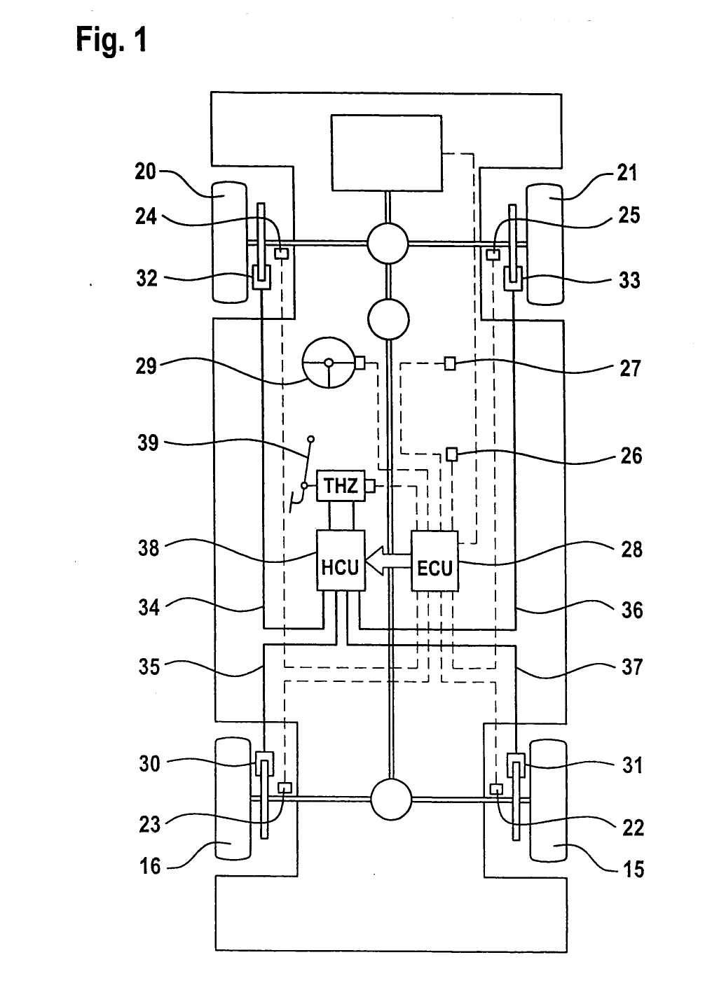

The FIG. 1 embodiment represents a vehicle with ESP control system, hydraulic brake system, sensor system and communication means. Of course, it is also possible to configure the brake system as an electrohydraulic or electromechanical brake. The four wheels are designated by reference numerals 15, 16, 20, 21. One wheel sensor 22 to 25 is provided on each of the wheels 15, 16, 20, 21. The signals are sent to an electronic control unit 28 determining the vehicle speed v_{Ref} from the wheel rotational speeds by way of predetermined criteria. Further, a yaw rate sensor 26, a lateral acceleration sensor 27, and a steering angle sensor 29 are connected to the electronic control unit 28. Each wheel additionally includes an individually controllable wheel brake 30 to 33. The brakes are hydraulically operated and receive pressurized hydraulic fluid by way of hydraulic lines 34 to 37. Brake pressure is adjusted by means of a valve block 38, said valve block being actuated independently of the driver on command of electric signals that are generated in the electronic control unit 28. The driver is able to introduce brake pressure into the hydraulic lines by way of a master cylinder actuated by a brake pedal. Pressure sensors P that allow sensing the driver's braking demand are provided in the master cylinder or the hydraulic lines. The electronic control unit is connected to the engine control device preferrably by way of a bass an interface (CAN).

By way of the ESP control system with brake system, sensor system and communication means including the components
Four wheel speed sensors
Pressure sensor (P)
Lateral acceleration sensor (LA)
Yaw rate sensor (YR)
Steering angle sensor (SWA)
Individually actuatable wheel brakes
Hydraulic unit (HCU)
Electronic control unit (ECU)
   it is possible to forecast a critical driving situation and, preferably, avoid it without the use of additional sensors.

The target of the disclosed method for rollover prevention shall be quasi-static cornering maneuvers, that means the condition of the vehicle (preset steering angle value, speed, yaw rate, and lateral acceleration) changes only ‘slowly’ and, thus, also the rollover tendency is increased comparatively ‘slowly’. Consequently, all hydraulic provisions may also operate with relatively low time gradients.

In order to reduce or prevent the slowly developing rollover tendency, it is necessary to reduce the vehicle speed and/or counteract further speed increase in time following the above explanations. In addition, yaw motion of the vehicle (yaw rate) should be decreased from the very beginning, or its further buildup prevented, so that rather an understeering vehicle performance with lower lateral acceleration will occur due to the hydraulic action of the method. Apart from the positive influence on the yaw dynamics in the sense of reducing the lateral acceleration, also the prevention of further steering angle development by the driver is an important design criterion to impart a feedback about the situation to the driver and induce him/her earlier to speed reduction. This is similarly achieved by producing a rather understeering vehicle performance.

The disclosed method basically uses the control algorithms of ESP and modifies them in the quasi-stationary rollover-relevant situation in a manner appropriate to comply with the mentioned requirements. As this occurs, the yaw behavior of the vehicle and, thus, the lateral acceleration of the reference model (linear single-track model for lateral dynamics) is limited to a defined value within the limits of producing nominal values, provided that a quasi-stationary vehicle performance at a high lateral acceleration level was detected. This limitation also limits the nominal yaw behavior of the vehicle to a value so that at a correspondingly high real yaw rate of the vehicle, an oversteer situation is considered to prevail which is followed by pressure increase on the curve-outward front wheel exactly as with the ESP intervention logic. The real vehicle performance, however, may still be neutral or even already understeering in this situation. This prevents an understeering intervention from the very beginning, which is possibly initiated already based on the non-modified ESP calculation of nominal values. This is important because the understeering intervention (pressure buildup on the curve-inward rear wheel) is beneficial to the course holding (yaw rate is increased), yet the rollover tendency is augmented.

The demanded target criteria for the rollover prevention method are satisfied by the described pressure buildup of the ESP oversteering intervention in the rollover-relevant situation, that means a more understeering, steering-inhibiting and braked, i.e. speed-reduced, vehicle condition is brought about. In this case, the applied yaw torque will counteract the inward turning tendency of the vehicle that is provoked by braking. It is further favorable that an aggravation of the situation by the driver (increase of the steering angle or further increase of the vehicle speed and, thus, increase of the yaw rate of the vehicle as well as difference in relation to the limited nominal yaw rate) is counteracted by an increased pressure buildup. Equally, appropriate reverse steering of the driver or braking will terminate the intervention.

The most important elements of solution are the detection of the rollover-relevant quasi-stationary situation, the way of maintaining the modified ESP control and the limitation of the lateral acceleration of the ESP reference model.

Influencing the ESP reference model is initiated when
a) the vehicle yaw acceleration is lower than a limit value (preferably 20 to 30 degrees/s²)
b) the steering angle velocity is lower than a limit value (preferably 100 to 200 degrees/s)
c) the vehicle lateral acceleration exceeds a limit value (preferably 7 to 8 m/s²)
d) ESP control does not take place.

Outside active ESP control, influencing the reference model is stopped when the conditions a) or b) are violated or the lateral acceleration drops by a defined value below the lateral acceleration limit mentioned under c) (hysteresis is preferably 1 to 2 m/s²). The conditions a) and b) are obviated for the detection in another embodiment.

When ESP control is active, influencing the ESP reference model is stopped only with termination of the control.

The lateral acceleration condition of the reference model is defined according to the following relation:
(\dot{Ψ}+\dot{β})v=α_{q} (1)
where
\dot{Ψ}—yaw rate of the vehicle
\dot{β}—tire slip angle velocity of the vehicle
v—vehicle speed
α_{q}—lateral acceleration of the vehicle.

With a limited reference model the condition of the reference vehicle is calculated under the secondary condition that a lateral acceleration limit of preferably 4 to 6 m/s² is not exceeded (values must take into consideration entry and exit threshold of the ESP control algorithm).

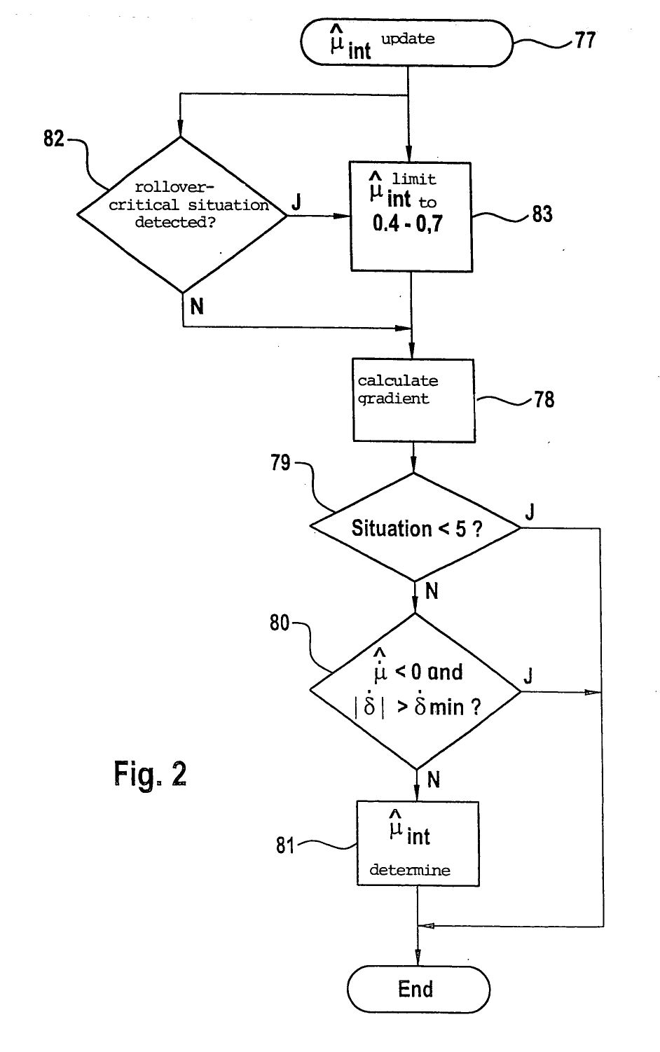

A preferred possibility of realizing this secondary condition is illustrated in FIG. 2. It consists in limiting the current and the initial coefficient of friction calculated by the ESP algorithms to a top threshold value (preferably 0.4 to 0.6) in order to mathematically limit the lateral force level occurring and, hence, the lateral acceleration level α_{q} according to
α_{q,limit}=βg (2)
(balance in forces at the vehicle in crosswise direction). g refers to the acceleration due to gravity (9, 81 m/s²).

FIG. 2 shows an excerpt of a flow chart for updating an internal coefficient of friction.

The current coefficient of friction is determined only when the ESP controller enters into the control. In order that the ESP controller enters into the control, a limited initial coefficient of friction is predefined when a rollover-relevant driving situation is detected (at least one of the conditions a) to d) mentioned under 1.2.1 is satisfied). Since, however, an assessed coefficient of friction does not yet prevail in the beginning upon entry into the control, the limited initial coefficient of friction μ=0.4 to 0.7 is set also at the beginning of the control. When the ESP control responds to a momentary driving situation, one may assume that the vehicle is at least close to the limit range of imminent rollover driving situations. Thus, the instantaneous coefficient of friction of the roadway can be concluded from looking at the current measured variables on the vehicle. The coefficient of friction is determined for the first time upon entry into the control, linked to a subsequent updating phase for the limitation of the nominal yaw rate to physically appropriate values. Based on the originally predefined coefficient of friction μ=0.4 to 0.7, a maximum coefficient of friction \hat{μ} is determined upon entry into the control and then made the basis for the calculation of the additional yaw torque M_{G}.

Initially an internal coefficient of friction \hat{μ}ᵢₙₜ is calculated from the measured lateral acceleration aₗₐₜₑᵣₐₗ and a calculated value for the longitudinal acceleration along which corresponds to the instantaneous coefficient of friction under the assumption that there is a complete utilization of grip. Since it must be assumed, however, that the maximum adhesion has not yet been reached upon entry into the control, a higher coefficient of friction \hat{μ} is allocated to the internal coefficient of friction \hat{μ}ᵢₙₜ by means of a table, a characteristic curve, or a constant factor. This coefficient of friction \hat{μ} is then sent to the control. It is thus possible to calculate in the next computing operation with a nominal yaw rate that is adapted to the coefficient of friction of the roadway and to improve the control. The internal coefficient of friction is determined according to the relation

$${\hat{μ}}_{int} = \frac{\sqrt{{a}_{lateral}^{2} + {a}_{long}^{2}}}{g} \qquad ( 3 )$$

where αₗₐₜₑᵣₐₗ=lateral acceleration and α_{long}=longitudinal acceleration.

The assessed coefficient of friction must be updated further even while ESP control acts on the vehicle because a change in the coefficient of friction could occur during control.

The criteria for updating the internal coefficient of friction \hat{μ}ᵢₙₜ are illustrated in FIG. 2. In field 77, updating of the internal coefficient of friction \hat{μ}ᵢₙₜ defined according to relation (3) is started. When a situation with rollover hazard—as described before—is identified in step 82, the internal coefficient of friction is limited in step 83 when \hat{μ}ᵢₙₜ reaches 0.4 to 0.7. In the absence of an imminent rollover situation, the internal coefficient of friction is calculated without limits.

Based on the internal coefficient of friction that is limited when a driving situation with rollover hazard is detected, the time derivatives of the previously produced assessed coefficients of friction \hat{μ} or \hat{μ}ᵢₙₜ as well as the steering angle (δ) are produced in step 78.

When it is detected in step 79 that the vehicle is neither at standstill nor in straightforward driving, namely that one of the situations <6> to <9> (6=rearward driving, 7=constant cornering, 8=accelerated cornering, 9=decelerated cornering) prevails, the results of step 78 will be evaluated in step 80. Only when a declining coefficient of friction cannot be attributed to a steering maneuver will the coefficient of friction be determined. Updating of the coefficient of friction will not take place if either the vehicle is straightforward driving—forward or rearward—or at standstill, or decrease of the assessed coefficient of friction \hat{μ} must be attributed to a steering maneuver.

1-11. (canceled)

12. Method for modifying a driving stability control of a vehicle comprising the steps of:
converting a steering angle (δ) and a driving speed (v) into a nominal value of a yaw velocity (\dot{Ψ}ₙₒₘᵢₙₐₗ) on the basis of a vehicle model defined by running characteristics,
comparing the nominal yaw velocity with a measured actual value of the yaw velocity (\dot{Ψ}_{measured}), and calculating a yaw torque (M_{G}) value, and according to the result of the comparison, defining an ESP intervention which produces an additional yaw torque by way of pressure quantities applied to the wheel brakes of the vehicle, said additional yaw torque adapting the measured yaw velocity (\dot{Ψ}_{measured}) to the calculated yaw velocity (\dot{Ψ}ₙₒₘᵢₙₐₗ) using a model-based coefficient of friction whose output signals (μ) are sent to the vehicle model and taken into consideration in the calculation of the nominal value of the yaw velocity (\dot{Ψ}ₙₒₘᵢₙₐₗ),
limiting the coefficient of friction to a value below a maximum allowable coefficient of friction (μₘₐₓ) in dependence on variables representative of at least a maximum lateral acceleration or variables derived therefrom.

13. Method as claimed in claim 12, wherein the coefficient of friction is limited to values between 0.4 and 0.7.

14. Method as claimed in claim 12, wherein the coefficient of friction is limited when at least one of the following conditions is satisfied:
a vehicle yaw acceleration is lower than a limit value, preferably lower than 20 to 30 degrees/s²,
a steering angle velocity is lower than a limit value, preferably lower than 100 to 200 degree/s,
a vehicle lateral acceleration exceeds a limit value, preferably 7 to 8 m/s², ESP control does not take place.

15. Method as claimed in claim 12, wherein the ESP intervention is executed as ESP oversteering intervention.

16. Method as claimed in claim 12, wherein the ESP oversteering intervention occurs with neutral or understeering driving performance.

17. Method as claimed in claim 12, wherein said ESP intervention includes the step of commencing ESP control while the driving performance of a vehicle is still stable under ESP criteria, according to a limitation of one or more input variables of a reference model determining the running characteristics of a linear single-track model.

18. Method as claimed in claim 17, wherein the coefficient of friction, or the lateral acceleration, or the steering angle velocity represent the one or more input variables.

19. Method as claimed in claim 12, wherein said ESP intervention is effective for preventing rollover of the vehicle about its longitudinal axis.

20. Method as claimed in claim 12, wherein the ESP intervention is effective for preventing rollover of a vehicle about its longitudinal axis, and wherein the ESP intervention includes the step of commencing ESP control when the driving performance of a vehicle is still stable under ESP criteria, according to a limitation of an input variable of a reference model determining the running characteristics of a linear single-track model.

21. Method as claimed in claim 20, wherein the coefficient of friction, or the lateral acceleration, or the steering angle velocity are sent as limited input variable to the reference model.
